(19) United States
(12) Patent Application Publication
(10) Pub. No.: US 2007/0144035 A1
(43) Pub. Date: Jun. 28, 2007

(54) Laundry dryer

(75) Inventors: Seung Bong Choi, Gyeongnsangnam-do (KR); Hong Myong Cho, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC, Youngdungpo-gu (KR)

(21) Appl. No.: 10/556,553

(22) PCT Filed: Jul. 28, 2005
(86) PCT No.: PCT/KR05/02461

§ 371 Date: Feb. 12, 2007

(30) Foreign Application Priority Data
Jul. 30, 2004 (KR) 10-2004-0060018

(51) Int. Cl. F26B 21/00; F26B 19/00

(52) U.S. Cl. 34/524; 34/89

(57) ABSTRACT

The present invention provides a new type of a laundry dryer and a method thereof for performing an optimal dying process through obtaining information on the various kinds of the clothes introduced into a drum comprising a reader unit for receiving a signal from an information tag attached to each piece of the laundry, to obtain information on drying each piece of the laundry have stored in the information tag, and a control unit for receiving information obtained by the reader unit and setting a drying cycle with reference to at least one of a drying temperature and a drying time by using the information received, and for controlling a driving of a driving part to perform a drying cycle. Also, the control method thereof comprises an information obtaining step for obtaining information on drying from each information tag attached to each piece of the laundry, an operation setting step for setting a control algorithm to operate at least one of a fan and a heating part with reference to the obtained information on drying, and a performing drying step for performing a drying cycle according to the set control algorithm, controlling the fan and the heating part.

### TECHNICAL FIELD

The present invention relates to laundry dryers, and more particularly, to laundry dryers and methods thereof which can perform optimal drying automatically by means of obtaining various kinds of information on the clothes introduced into a drum for drying them automatically.

### BACKGROUND ART

Generally, dryers are apparatuses for drying laundry, such as clothes introduced into a drum with hot air heated by electric heaters or gas burners etc.

FIG. 1 illustrates a diagram showing an inside of a related art laundry dryer.

The related art laundry dryer comprises a body 10, a drum 20, a door 40, a driving part 50, a heating part 60, and a fan 70.

The body 10 has an opening 11 in front and a rim portion 30 is mounted on the opening 11.

The drum 20 is rotatably mounted in the body 10. On an inside wall of the drum 20, a plurality of stirring pieces 21 is provided for stirring the laundry such as clothes.

The door 40 is rotatably installed on the body 10 for opening/closing the opening 11 selectively.

The driving part 50 is fixedly secured below an inside of the body 10 for generating a driving force to rotate the drum 20. The driving part 50 is provided with a driving motor.

The heating part 60 is mounted in a hot air supplying passage 81 so as to heat air moving inside of the hot air supplying passage 81. The heating part 60 is provided with an electric heater.

At this time, the hot air supplying passage 81 is employed to lead the air moving for drawing outside air toward an inside of the drum 20 and discharging it toward an outside of the body 10.

Also, the fan 70 is provided in communication with a hot air discharging passage 82 for discharging dry air moving inside of the rum 20 outside.

Thus, once the user introduces the laundry which he/she wants to dry into the drum 20 and then makes a drying cycle performed, a control unit (not shown) operates the heating part 60 and the driving part 50.

According as the fan 70 is operated along with that, air drawn inside of the body through an inlet of the hot air supplying passage 81 rises high in temperature. In succession, the hot air of a high temperature is forcibly drawn into the drum 20 through the hot air supplying passage 81.

As described above, the hot air drawn into the drum 20 is moved by the fan 70, therewith drying the wet laundry. After that, the hot air is discharged outside of the body 10 through the hot air discharging passage 82.

In that process, the drum 20 is rotated, and the stirring pieces 21 formed on the inside wall of the drum 20 contacts the laundry to prevent the laundry from entangled each other.

When the laundry is dried by a repetitive performance of the above process, the door 40 is opened and then the laundry is taken out.

However, the related art laundry dryer as described above has an inconvenience that the user is required to set various operations such as setting a drying time, because there are no automatic settings.

For example, the user is required to check the whole amount of the laundry introduced into the drum 20, that is, various kinds of clothes in a state of being wet and the quality of the same, followed by performing an appropriate operation by him/herself.

Accordingly, in case that a kind of clothes required to be dried at a low temperature is introduced into the drum 20 without the user's noticing, damage of the clothes is caused, because the kind of the clothes is dried at a high temperature not at a low temperature.

Recently, due to development of information technology, a RFID (Radio frequency Identification) tag may be attached to many kinds of clothes for making a distribution management and an information management over the clothes possible.

The RFID tag is a kind of a memory chip which has a predetermined region for memorizing various kinds of information concerned with the clothes. Also, various kinds of information and/or additional information may be recorded in the memory region of the RFID tag.

However, the memorized information in the RFID tag on the clothes is mainly used for the distribution management of the clothes but is not applied to a drying cycle.

Korean Registered Patent Publication No. 1995-0011598 discloses a washing information input device for a washing machine comprising an information medium attached to the clothes for recording washing information, a washing information input sensing means mounted to an appropriate position of the body for sensing the washing information recorded by the information medium, and a system control means for controlling the entire system of the washing machine based on the washing information sensed at the washing information input sensing means.

That is, the technical features of Korean Patent No. 1995-0011598 described above are enabled to obtain information on washing from the information media attached to the clothes and to perform an appropriate washing process according to the information obtained through the information medium on the clothes.

Also, Japan Laid Open Patent Application No. 2002-360968 discloses a washing apparatus in which a non-contact identification unit is used comprising a reader for receiving a signal from the RFID tag attached to the clothes to memorize information, a central information processing unit having a holder for informing information the reader reads, and a control part for setting or converting a washing mode.

That is, Japan Laid Open Patent Application No. 2002-360968 is so as to prevent an inappropriate washing process after obtaining washing information from the RFID tag attached to the clothes.

However, each technical feature of the related arts described above is applied only to the washing process, not to a device performing laundry drying such as a laundry dryer.

Furthermore, each technical feature of the related art described above only gives information whether the clothes are possible to be washed or not. An automatic control is not actually performed.

### TECHNICAL PROBLEM

An object of the present invention devised to solve the problem is to provide a new type of a laundry dryer and a method thereof for performing an optimal dying process through obtaining information on the various kinds of the clothes introduced into a drum.

### TECHNICAL SOLUTION

To achieve this object and other advantages and in accordance with the purpose of the invention, a laundry dryer comprises a reader unit for receiving a signal from an information tag having information concerned with drying memorized on each piece of the laundry, followed by obtaining and reading the memorized information in the information tag; a control unit for setting a drying cycle with reference to at least one of a drying temperature and a drying time by means of using the obtained information concerned with drying from the reader unit.

Also, to achieve this object and other advantages and in accordance with the purpose of the invention, a control method of a laundry dryer according to the present invention comprises an information obtaining step in which each drying information is obtained from each information tag on each piece of the laundry; an operation setting step in which a control algorithm is set for at least one operation of a fan and a heating part with reference to the drying information; and a drying performing step in which a drying cycle is performed with controlling the fan and the heating part according to the set control algorithm.

### ADVANTAGEOUS EFFECTS

A laundry dryer and a control method thereof according to embodiments of the present invention has a first advantageous effect that an operation on an optimal drying condition is possible, because drying information of each piece of the laundry such as clothes is identified by means of using a non-contact method and, after that, the drying condition is determined with reference to the drying information.

A laundry dryer and a control method thereof according to embodiments of the present invention has a second advantageous effect that a laundry damage caused by a drying operation is prevented in advance, because a drying cycle is operated on various conditions even if various kinds of laundry are dried in a state of being mixed each other.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates a side sectional view schematically showing an inside of a related art laundry dryer;

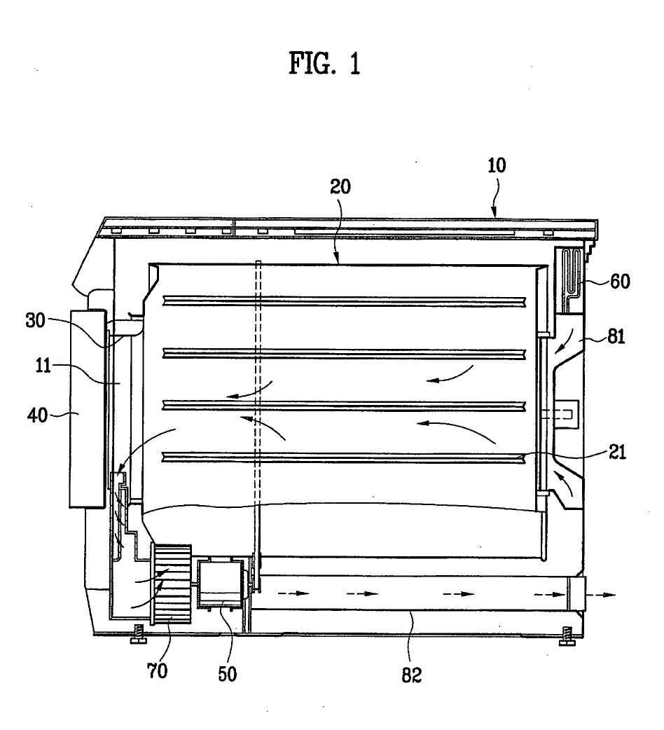

FIG. 2 illustrates a side sectional view schematically showing an inside of a laundry dryer according to the present invention;

FIG. 3 illustrates a flow chart schematically showing a control method of a laundry dryer according to a first embodiment of the present invention;

FIG. 4 illustrates a flow chart schematically showing a control method of a laundry dryer according to a second embodiment of the present invention; and

FIG. 5 illustrates a flow chart schematically showing a control method of a laundry dryer according to a third embodiment of the present invention.

### BEST MODE FOR CARRYING OUT THE INVENTION

Reference will now be made in detail to the preferred embodiments of the present invention, examples of which are illustrated in the accompanying drawings.

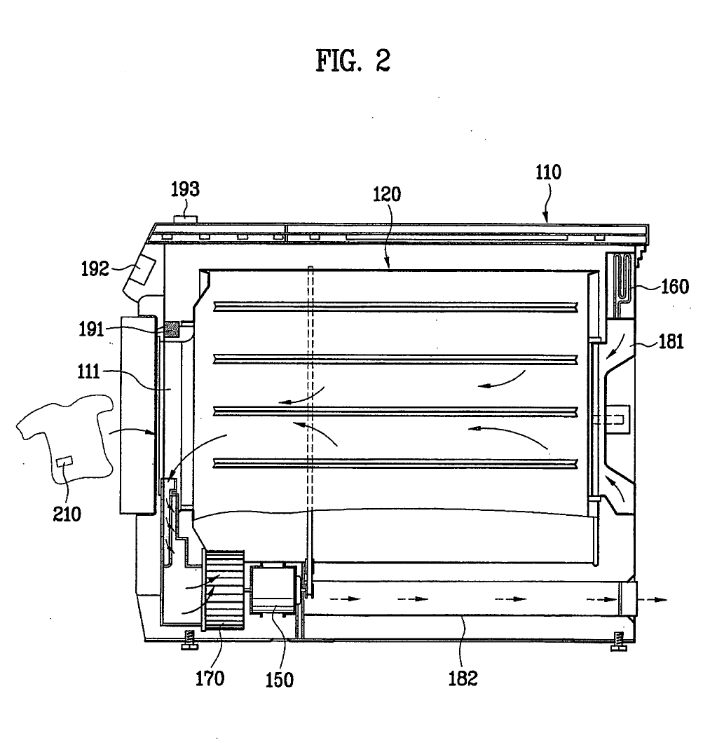

Referring to FIG. 2, the laundry dryer according to the present invention comprises a body 110, a drum 120, a driving part 150, a heating part 160, a fan 170, a reader unit 191, and a control unit 192.

The body 110 forms an exterior of the laundry dryer, and an opening 111 for introducing laundry is formed in front of the body 110.

The drum 120 is mounted in the body 110 to form a drying room and rotated by driving of the driving part 130.

The heating part 160 is mounted inside of a hot air supply passage 181 for heating air moving inside of the hot air supply passage 181. The heating part 160 may be provided with a general electric heater.

The hot air supply passage 181 draws air toward an outside of the body 110 and leads the air to move inside of the drum 120.

The fan 170 is operated to discharge dry air moving inside of the drum 120 toward an outside of body 110. The fan 170 is provided at an air inlet of a hot air discharge passage 182.

The reader unit 191 is operated to exchange a signal with an information tag attached to each piece of the laundry introduced into the drum 120 and then to obtain memorized information from the information tag 210.

The reader unit 191 may be mounted on the opening 111 of the body 110.

The information tag 210 may be a RFID (Radio Frequency Identification) tag enabled to record supplementary information. The reader unit 191 may be a RF reader to exchange a signal with the RFID tag or to record new information in the RFID tag.

Other various configurations enabled to exchange information by means of using a non-contact method may be applied as well as the information tag 210 formed with bar codes and the reader unit 191 formed with a barcode reader.

Also, at least one of an appropriate drying condition, a laundry object weight, and a laundry object quality may be included in the drying information memorized in the information tag 210 attached to each drying object.

At this time, the appropriate temperature may include a preferred drying temperature and a drying time.

The control unit 192 controls driving of the driving part 150 of the laundry dryer.

Specifically, the control unit 192 obtains information on the whole laundry object introduced into the drum 120 from the reader unit 191, and sets a control algorithm with reference to at least one of the drying temperature and the drying time by means of using the obtained drying information. In succession, the control unit 191 controls driving of the driving part 150, the fan 170 and the heating part 160 according to the contents of the set up algorithm.

The laundry dryer according to the embodiments of the present invention may further comprise a noticing unit 193 for notifying the user of various kinds of error messages or introduction messages.

The noticing unit 193 may be a screen such as a LCD (Liquid Crystal Display) enabled to display information or a speaker sounding ‘beep’.

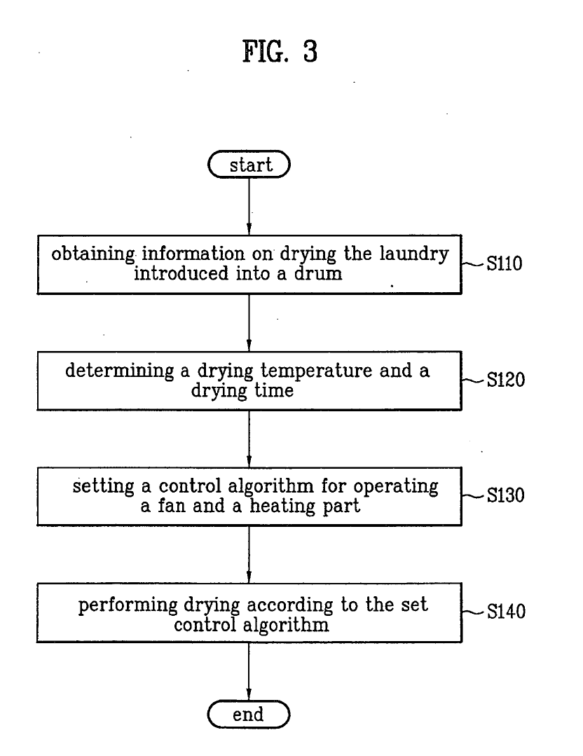

Referring to FIG. 3, a control method of a laundry dryer according to the first embodiment of the present invention will be described in detail.

First, the user introduces the laundry (such as clothes) after a washing process into a drum 120.

In that case, a reader unit 191 obtains (S110) drying information on the laundry from an information tag 210 attached to each piece of the laundry introduced into the drum 120.

The reader unit 191 exchanges a signal with the information tag in a non-contact way, and obtains the drying information memorized in the information tag 210.

The proper moment for the reader unit's obtaining the drying information of each piece of the laundry may be at a time after each piece of the laundry being introduced into the drum 120. Of course, it may be selectively in the middle of the laundry's being introduced into the drum 120.

Furthermore, at least one of an appropriate drying condition, a weight of the laundry, and a quality of the laundry material may be included in the drying information which the reader unit 191 obtains.

The appropriate drying condition may include either a drying temperature or a drying time.

The drying temperature may be a temperature which does not cause the laundry damaged and the clothier recommends. Also, the drying time may be a time which does not cause the laundry damaged and the clothier recommends.

Once the drying information is obtained by means of the above process, a control unit 192 is provided with the drying information.

Hence, the control unit 192 sets a drying cycle for drying the laundry with reference to the drying information provided by the reader unit 191.

The drying information which will be a reference for setting the drying cycle includes an appropriate drying condition and a quality of the laundry material.

That is, after a drying temperature and a drying time is determined (S120) according to the appropriate drying condition and the quality of the laundry material, a control algorithm for operating a fan 170 and a heating part 160 is set (S130) according to the drying temperature and the drying time.

The control algorithm includes a rotation speed of the fan 170, an operation period and/or an operation time of the fan 170, an operation temperature of the heating part 160, an on-off period and/or a heat-generating time of the heating part 160.

For example, once the laundry is identified as material such as nylon or silk easily transformed at a high temperature (for example more than 60° C.) through the information provided by the reader unit 191, a range of the drying temperature (for example less than 60° C.) free from a risk of the above transformation, and a drying time are determined. Hence, the control algorithm for operating the fan 170 and the heating part 160 is set.

Once the control algorithm for operating the fan 170 and the heating part 160 is set, the control unit 192 performs (S140) the drying cycle according to the set control algorithm.

According to the second embodiment of the present invention, a weight of the laundry is further included in the control algorithm of the first embodiment when setting the control algorithm for operating the fan 170 and the heating part 160.

In case that the weight of the laundry is heavier than the reference weight set in the control unit 192, drying is not performed to a degree in which the user is satisfied. In case that the weight of the laundry is lighter than the reference weight set in the control unit 192, drying is performed too much even before the drying cycle is completed.

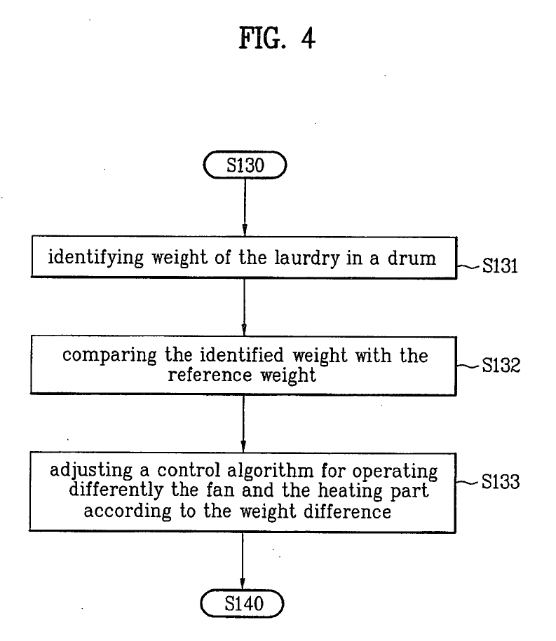

Therefore, as shown in a flow chart of FIG. 4 according to the second embodiment of the present invention, a series of steps are further included such as an identifying step S131 in which the weight of the laundry in the drum 120 is identified, a comparing step S132 in which the identified weight of the laundry is compared with the set reference weight, and an adjusting step S133 in which the fan 170 and the heating part 160 are operated differently according to the results of the comparing step (that is, a difference of the weight).

The reference weight is a weight determined with reference to the drying temperature and the drying time for the basic drying operation.

In case that the identified weight is heavier than the reference weight, the control algorithm is adjusted so that the fan 170 may send a lager amount of air to the drying objects than the amount of air when the fan 170 is operated with reference to the reference weight set in the S130 step. On the other hand, in case that the identified weight is lighter than the reference weight, the control algorithm is adjusted so that the fan 170 may send a smaller amount of air to the drying objects than the amount of air when the fan 170 is operated with reference to the reference weight set in the S130 step.

The control algorithm adjustment of the fan 170 is adjusting a rotation speed, an operation period, and an operation time of the fan 170.

In case that the identified weight is heavier than the reference weight, the control algorithm is adjusted so that the heating part 160 may dry the laundry for a longer time than a time when the heating part 160 dries the drying objects with reference to the reference algorithm set in the S130 step. On the other hand, in case that the identified weight is lighter than the reference weight, the control algorithm is adjusted so that the heating part 160 may dry the drying objects for a shorter time than a time when the heating part 160 dries the laundry with reference to the reference algorithm set in the s130 step.

The laundry in the drum 120 is in a state of containing moisture. Thereby, the weight of the laundry read in the reader unit 191 may be different from the actual weight of the laundry introduced into the drum 120.

Therefore, it is preferred, but not necessary, that the weight of the laundry is identified into the actual weight of the laundry introduced into the drum 120, containing moisture.

After the identified actual weight of the laundry containing moisture is compared with the weight identified with reference to the information obtained from the reader unit 191, the control algorithm adjusted in the S133 step is additionally adjusted according to the difference between the two weights.

In other words, the control algorithm is adjusted for the operation time to increase more than the operation time with reference to the control algorithm set in the S133 in proportion as the difference between the confirmed actual weight of the laundry and the entire weight thereof.

To identify the weight of the laundry in a state of being introduced into the drum 120, a supplementary weight sensor (not shown) may be further provided or the load in the driving unit may be read.

Also, after identifying information on a degree of the laundry’ absorbing moisture from the drying information attached to each piece of the laundry obtained by the reader unit 191, the weight is adjusted additionally with reference to the moisture absorbing degree, thereby the precise weight of the laundry in the drum 120 being identified.

In control methods according to the first embodiment and the second embodiment of the present invention, a drying method is set on an optimal condition automatically in case that the laundry is the same kind. However, in case that the laundry mixed in more than two kinds is introduced into the drum 120, it is preferred but not necessary that the drying cycle is separately operated according to each kind of the laundry.

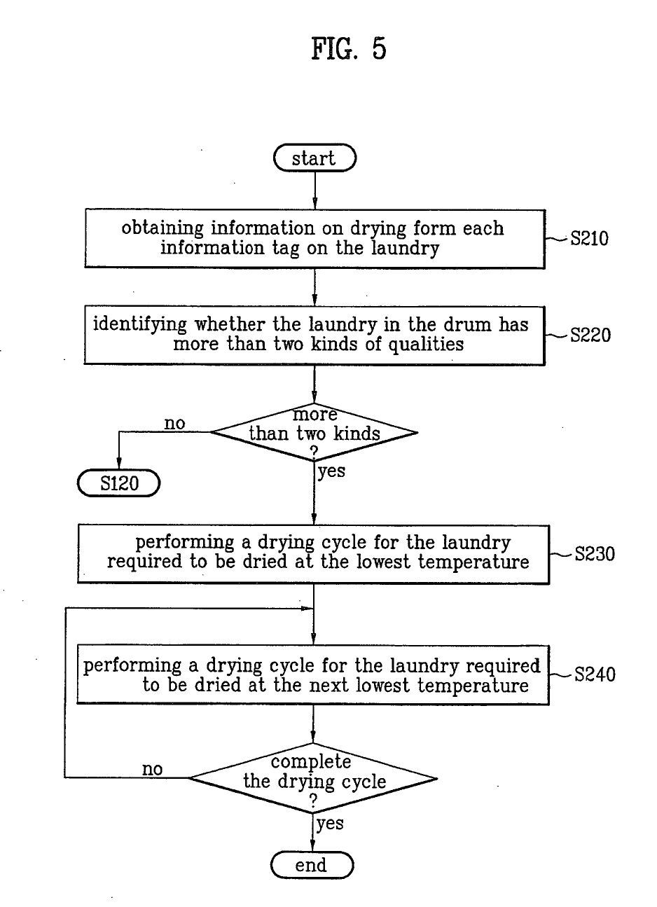

Hence, according to the third embodiment of the present invention in the flow chart of FIG. 5, the control unit 192 identifies (S220) that more than two kinds of the laundries are introduced into the drum 120 out of the drying information provided by the reader unit 191 in the S210 step in which the reader unit 191 obtains the drying information on each piece of the laundry,

In case that more than two kinds of the laundries are introduced into the drum 120, a drying cycle for the laundry required to be dried at a relatively low temperature may be performed (S230) preferentially and in succession a drying cycle for the laundry required to be dried at a high temperature may be performed.

At that time, once the drying cycle for the laundry required to be dried at a relatively low temperature is completed, the user is notified through the notifying part 193 so that the laundry dried at a relatively low temperature may be taken out.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention has an industrial applicability, because it is a new type of a laundry dryer enabled to dry the laundry efficiently.

1. A laundry dryer comprising:
a reader unit for receiving a signal from an information tag attached to each piece of the laundry, to obtain information on drying each piece of the laundry have stored in the information tag; and
a control unit for receiving information obtained by the reader unit and setting a drying cycle with reference to at least one of a drying temperature and a drying time by using the information received, and for controlling a driving of a driving part to perform a drying cycle.

2. The laundry dryer claimed as claim 1, wherein the information tag is a RFID (Radio Frequency Identification) tag which additional information may be written thereon, and
The reader unit is a RFID reader which exchanges a signal with the RFID tag to receive information from the RFID tag, or to write new information on the RFID tag.

3. A control method for a laundry dryer comprising:
an information obtaining step for obtaining information on drying from each information tag attached to each piece of the laundry;
an operation setting step for setting a control algorithm to operate at least one of a fan and a heating part with reference to the obtained information on drying; and
a performing drying step for performing a drying cycle according to the set control algorithm, controlling the fan and the heating part.

4. The control method as claimed in claim 3, wherein the information obtaining step is performed by class after each piece of the laundry is introduced into a drum.

5. The control method as claimed in claim 3, wherein the information obtaining step is performed respectively in the middle of introducing each piece of the laundry into the drum.

6. The control method as claimed in claim 3, wherein the information on drying obtained from the information tag attached to the each piece of the laundry in the information obtaining step includes at least one of an appropriate drying condition, weight of the laundry, and a quality of the laundry material.

7. The control method as claimed in claim 6, wherein the appropriate drying condition includes at least one of a drying temperature and a drying time.

8. The control method as claimed in claim 3, wherein the control algorithm is set with reference to at least one of the drying temperature and the drying time.

9. The control method as claimed in claim 3, further comprising:
a weight identifying step for identifying weight of the laundry in the drum with reference to the information obtained in the information obtaining step;
an algorithm adjusting step for adjusting the control algorithm set in the operation setting step so that the fan and the heating part may be operated differently according to the results of comparing the identified weight with the set reference weight.

10. The control method as claimed in claim 9, wherein the control algorithm is adjusted so that the fan may send a lager amount of air to the laundry than the amount of air when the fan is operated with reference to the reference weight set in the operation setting step, in case that the identified weight is heavier than the reference weight.

11. The control method as claimed in claim 9, wherein the control algorithm is adjusted so that the heating part may dry the laundry for a longer time than a time when the heating part dries the laundry with reference to the reference algorithm set in the operation setting step step, in case that the identified weight is heavier than the reference weight.

12. The control method as claimed in claim 9, further comprising:
an actual weight identifying step for identifying actual weight of the laundry introduced into the drum;
a control algorithm adjusting step for adjusting the control algorithm set in the operation setting step according to the difference between the identified weight and the entire weight of the laundry obtained in the information obtaining step.

13. The control method as claimed in claim 12, wherein the control algorithm is adjusted for the operation time to increase more than the operation time with reference to the control algorithm set in the operation setting step in proportion as the difference between the identified actual weight of the laundry and the entire weight thereof obtained in the information obtaining step.

14. The control method as claimed in claim 13, wherein identifying the actual weight of the laundry includes using a weight sensor or identifying a moisture absorbing ratio.

15. The control method as claimed in claim 3, further comprising a kind reading step for identifying the laundry introduced into the drum whether they are of the same kind of quality or more than two kinds of qualities.

16. The control method as claimed in claim 15, wherein in case that the laundry introduced into the drum are identified to have more than two kinds of qualities, a drying cycle for the laundry required to be dried at a relatively low temperature may be performed preferentially and in succession a drying cycle for the laundry required to be dried at a higher temperature than the relatively low temperature may be performed.
